(19) United States
(12) Patent Application Publication
(10) Pub. No.: US 2015/0170179 A1
(43) Pub. Date: Jun. 18, 2015

(54) SYSTEM AND METHOD FOR MUSIC DISTRIBUTION

(71) Applicant: Alex Burroughs, San Diego, CA (US)

(72) Inventor: Alex Burroughs, San Diego, CA (US)

(21) Appl. No.: 14/132,644

(22) Filed: Dec. 18, 2013

(51) Int. Cl. G06Q 30/02; G06Q 30/06; G06Q 10/02

(52) U.S. Cl. CPC G06Q 30/0222; G06Q 10/02; G06Q 30/0601

(57) ABSTRACT

A system for rewarding a legal purchase of music or live performance tickets by users is provided which allows communication over a network for user registration and sales of digital music and live performance tickets. Users legally purchasing music or live performance tickets over the system are provided with discounts to merchandise related to the artist or musical group producing the digital music or live performance.

### BACKGROUND OF THE INVENTION

1. Field of the Invention

The present invention relates to music-based social networking services. More specifically, the invention relates to an improved business method for providing incentives to fans for the legally purchasing of artists music, merchandise, and other products and an interface for musicians and music jobs. The invention is most preferably employable as an internet-based music provision service.

2. Prior Art

The goal of most musicians and artist alike is to have their music reach the masses, let their message be heard, and of course, make a living. However, it is well known that without proven ability to attract fans for sufficient recording sales, many record companies will not provide adequate compensation to artists. Further, with the advent of the internet and enhanced software and personal computers, it is possible for many recording artists to publish their own music which is sold or distributed directly to buyers and allowing them to skip the production companies.

However, the advent of music digitalization has also had a chilling effect in more recent years on the legal purchase of music from electronic retailers along with a reduction in the remuneration to the artists for their creations. Listeners and fans can in fact download music in various file formats from websites which host and download such songs and albums illegally. Such sites and servers are frequently in foreign countries and therefor almost impossible to close or discourage.

In recent years, a number of firms such as APPLE have become predominate distributors of digitized music in the ever more web-connected world. Additionally, music listeners have grown up with digitized music rather than CD or tape-based media carrying music. Additionally, record companies have become less inclined to sign new musical groups to contracts, and newer groups have discovered they can sell directly to consumers and leave the larger record companies out of the loop.

As an unfortunate consequence of the centralization of digital distributors of music, the lower importance of record labels and producers, and direct selling by new musical groups, and the illegal hosting and downloading of music files, many artists have seen a lessening of income from royalties on recordings. Newer groups, as well as long-established musicians, have been considering other methods of increasing or even maintaining revenues. Additionally, fans do not have a feeling of connection with the groups or other fans of the group, but for those that take the time to register as fans on a group-based site. Further, fans of one group, may never know of a group with a similar genre of music due to the fragmented nature of digital music on the internet.

In today's modern age the internet has provided a key roll in allowing almost any artist to expand to a global level and reach fans. With the emergence of social networking services, users from all over the world can connect, chat, and interact with another user in virtually any other location in the world with an internet connection. Recently, more specialized music-based social networking services have arisen to provide an opportunity for musicians and artists to submit their music to the worldwide stage for any and all ears to hear. Some of these sites include SPOTIFY, ITUNES PING, PANDORA, FLOTONES, and REVERBNATION to name a few. These, as well as others, have successfully provide a means to entertain the public by bringing the general fan closer to the music genre or artist they like. However, with the ability to stream music to ones personal computer or smart phone, and the proliferation of illegal downloading, record sales and artist compensation continue to see a decline.

For example, SPOTIFY is a music social networking service wherein advertisers pay the service to run ads. Free users must view ads in order to listen to music while paying users enjoy the service ad free. In order to stream music, SPOTIFY pays record companies to stream their music and in turn, the record companies pay the artists. However, as noted above, the compensation to the artists from the record companies is sparse.

ITUNES PING is another music-based social network wherein users can follow artists through photos and status updates, as well as allowing users to follow their friends and friends music interests. Ping further ties the social network service to the online marketplace wherein users can purchase songs. However, Ping does not provide any incentive to the users to purchase music from their favorite bands, or new groups. As a consequence, most users having grown up in a digitized music world, and having no real connection with the groups or music they prefer, have no reason to legally download and pay sites like ITUNES for the music they load to their digital players, especially since they can stream music from other sites for free. These and other conventional music-based social networking services similarly fall short since there is generally no personal connection with the artist or other fans, and no other incentive for users to purchase artist music or merchandise. Thus, artist compensation continues as generally inadequate.

As can be imagined, these services providing little to no financial gain to the artist are becoming undesirable to these artists and related affiliates. Musicians and artists alike spend countless hours, days, and years, perfecting their craft and producing a final product that their fans deserve. Profits merely continue to be seen by the site owners from advertisements and product placements directed to the fans that the artists themselves are drawing in. The musicians and artists driving the main traffic to these sites have therefor earned, and are due, enhanced financial restitution which these sites do not provide.

Second, conventional online music services lack in the ability to connect fans to other sources of favored-artist networking, such as touring, concerts, festivals, and artist merchandise, which in turn provide additional revenue for the artist. Although the conventional services may provide a means to promote or advertise upcoming shows, when the average consumer is bombarded with hundreds of ads a day, a simple promotion ad may not successfully engage the fan as the artist would desire.

As such, there is a continuing unmet need for an improved business method and service to provide a means for artists and musicians alike to effectively bring their product to the masses while additionally receiving financial restitution for their creations. Such a method should be easily used and advantageously be employable through conventional media such as web-based social networking. Such a method should provide users a reason to visit a music website and pay for legal downloading of music files. Such a web based business should also endeavor to encourage visitation through the socializing of like-minded music fans with each other, and by exposing such visitors to new groups which will further increase sales. Such a system and method should ideally provide rewards for user payment to addend an artist's live show or concert, and/or for legally purchasing the artist's albums.

### SUMMARY OF THE INVENTION

The device and method herein disclosed and described provides a solution to the shortcomings in prior art of digitized music distribution and achieves the above noted goals through the provision of a network-based business system for selling and distributing musical files in conjunction with a music-based social networking service and rewards system for legally purchasing music or paying to attend concerts. The method provides a user friendly service that aims to solve many of the problems associated with music sales and the music industry by encouraging users to legally purchase music online with the provision of discounts to visit music festivals and concerts and for the purchase music related merchandise. Alternatively the system can reward fans who pay to attend a concert with discounts to purchase merchandise and albums to encourage legal purchases. Further, through the provision of social networking of like-minded individuals, a spirit of comradery is also provided thereby encouraging use of the website. This combination is a means to provide users a reason to purchase their music or attend their concerts, thereby resulting in an enhanced revenue stream to the artists, producers, and record labels which concurrently will encourage new artists and the entire industry to expand.

As a brief note, although the disclosed method is preferably employed through a web-based online service, such as a social networking service, one skilled in the art may immediately recognize that the steps and practices set forth in this disclosure may similarly be employed through other conventional service methods without departing from the overall scope and intent of the invention as will become apparent upon further disclosure, and is anticipated. Further, the disclosed system and method herein, could easily be adapted into conventionally existing music sales sites and such is anticipated to be within the scope of this application.

The system herein, through the provision of an internet based service via an online service provider, provides users the ability to access a webpage wherein the user can then register an account. Thereafter, in addition to the ability to legally purchase music, and to purchase concert or performance tickets, the system provides the registered user with means for social networking with friends and during scheduled time frames, the artists.

In operation, users, by searching for the desired artists, and registering with the site, their interest in artists can be provided with news and updates regarding the artists' music, photos, concert touring dates, merchandise, etc., essentially connecting the user directly to the artists. Still further, users can stream artists' music for instant listening or similarly create playlists for continuous listening. When streaming music, as wells as browsing artists, advertisers will be provided with a means to present visual and audio advertisements wherein compensation to the service, record companies, and artists is provided in a conventional manner.

Users are further provided with online means to purchase artists' music, albums, merchandise, and other products. As an advantage over prior art of digital music sales, the invention includes the novel action of providing incentives for the user to purchase the artists' products and/or for attending the artist's live performance. These incentives are controlled by the site and the artists, and can include discounts on merchandise, discounted concert tickets and even free concert tickets. Because illegal sites for music will lack these artist-related and approved incentives, such incentives will urge users to attend the artist's live performances and/or purchase artists' albums legally, and will enhance the artists' revenues through increased album sales and merchandise sales.

Such inducements, which require artist approval or participation, as noted, would be unavailable on illegal music sites since the artists would never participate at such venues. The inducements to fans and purchases can be discounted or free tickets for the users/fans to attend concerts, festivals, and shows where their favorite artists will be performing. In the alternative, fans who pay to attend a live performance or concert, can be given discounts to purchase the digital album and merchandise. In addition or in place of free tickets, discounts on artist-related merchandise such as posters, clothing and the like can be provided to the fans and buyers. Such inducements being unavailable on pirate sites, will surely encourage actual purchase of music on the site herein and attendance at an artist's live performances.

Additionally, the method herein may allow for advertisers with further advertising means to communicate ads to fans and buyers. This can be through discounts and coupons for products of advertisers related to or sponsoring concerts and tours, or at the festivals and concerts to which music buyers receive admittance or discounted tickets. This increase of exposure to the advertiser aids in maintaining adequate revenue streams for the advertisers and affiliates, providing another means for solving many of the problems noted above.

Finally, in another mode of the system herein, the system will provide users a feature that helps connect users who play music, such as new bands, to find other musicians. For example, a first user may be a guitar player or a number of players, who need a drummer to accompany them in the San Diego region. Further they may require a drummer with a certain experience, age, musical interest, etc. Using the system, users in search of another musician, can search using a library of musician users who also have specifics about their musical talents and interests stored with the service provider. In the case of the drummer for instance, the drummer user, once they complete their profile, musical interest and experience profile, can upload soundtracks that users seeking fellow musicians can listen to and discern a musical nexus. The looking user can then get in contact with that user drummer to arrange for a group session and perhaps form a musical band. So therefore, not only does the system herein change the way users may listen, share, see, purchase, and connect to music and related merchandise, but the system may be employed to aid in creating new music and musical groups by providing a means for musicians to find like minded and creative users to work with.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of the invention to provide a business method which connects fans, artists, advertisers, and record companies in a social network.

It is another object of the invention to provide a business method that adequately solves the financial needs of artists, record companies, advertisers, and affiliates which has been conventionally lacking in the music industry.

It is yet another object of the invention to provide incentives to users/fans to legally purchase artists' music, albums, and merchandise in return for discounted or free concert tickets or merchandise discounts.

It is a further object of this invention to provide incentives to users and fans who attend an artist's live performance which will also encourage legal purchases of digital recordings.

It is still anther object of the invention to create and promote artists' tours, festivals, and concerts.

It is a still further object of this invention to provide a means for musicians to find fellow musicians with whom to create and play music.

### BRIEF DESCRIPTION OF DRAWING FIGURES

FIG. 1 shows a flow chart of the invention for providing incentives for legally purchasing music and associating like users.

FIG. 2 depicts a mode of the system with rewards provided to attendees of live performances in the form of discounts for recorded music and other goods.

### DETAILED DESCRIPTION OF THE PREFERRED

### Embodiments of the Invention

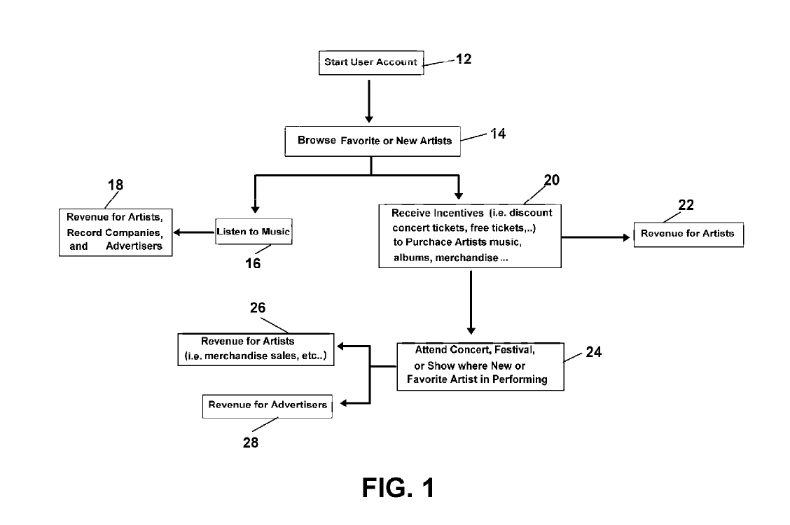

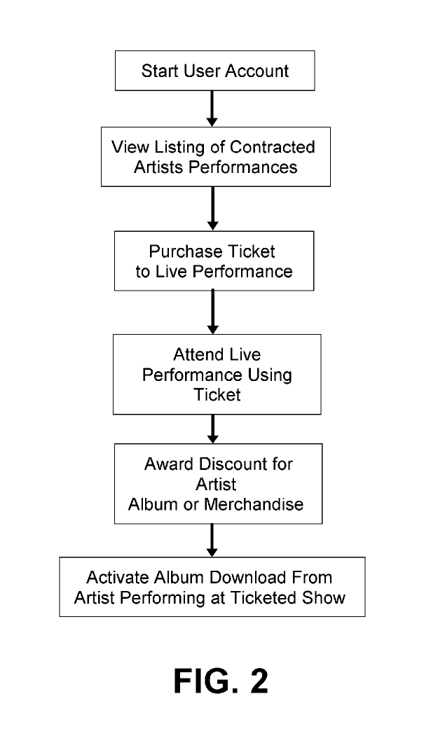

Now referring to the drawings in FIGS. 1 and 2, wherein similar components are identified by like reference numerals, there is seen in FIG. 1 a simplified flow chart of the actions of the method of implementing the system by the system provider of the present invention.

Through the disclosed web-based method, using software adapted to creating user profiles and communicating sign-up pages to the screens of new users, a subscribing user is first provided with a means to set up an account 12 with the service provided by the disclosed system. It is particularly preferred that the service account 12 is set up via an online based web service or website, however in yet other preferred modes the user may sign up or register at a booth or other type service at a concert venue, street fair, etc, or through television ad services for example.

In all preferred modes of the system herein, advertisers may be provided with means for direct advertising to the users such as through ad space at the particular booth, or displayed on the webpage of the service or through the provision of discounts on advertisers merchandise which encourage legally purchasing music. Such ads and discounts will be communicated to users based on their input personal profile, and their record of purchases using a relational database which tracks their music and musical group affinity.

It must be noted that although it is preferred that the disclosed business method is employed as a web based service those skilled in the art will recognize various other means of employment without departing from the overall scope and intent of the invention such as for instance sign up kiosks located in malls or at festivals. As such, the following description while referring in the most part to an online service should not be considered limiting in that manner.

In accordance with the mode of the method employing internet or web based services, once users register their personal profile and form an account, using software adapted to the task and communicated to users from the service provider server, the users will be provided with a first means of encouragement for legally purchasing music through the provision of a social networking service related to artists of interest and music of interest. From the user's sign up session and their created user profile, and using a relational database to associate users answering profile questions that show a relation to a particular music genre or group, users will be provided with access initially to groups of other users shown to have related music or group affinity. Such a social network may be provided for user sharing of discussions about favorite groups and artists, finding friends or finding like-minded friends interested in the same artists, sharing photos and videos, posting updates, and chatting with friends.

Further, it is of particular preference that the user, herein also referred to as a ‘fan’, can be provided with screens allowing them to search for their favorite artists 14, genres of music, browse new and upcoming artists, browse the artists their friends are listening to, and similarly receive news updates or ‘feeds’ about their favorite artists or music in question.

Using this initial user profile, and the input from the user cross referenced with the relational database of users and groups and music, and user searches, and voluntary inclusion inputs by the user, the user or fan is thus provided with an instant connection to the artists they enjoy and can maintain a virtual one-on-one connection with them thereby drawing them to the site where music is legally sold.

Further, employing software from the server of the system provider, and using ascertained legal digital copies of music owned by or purchased by the user, the user can create and share playlists of musical artist songs or albums for instant listening 16. In one favored mode, users may “broadcast” a play list and can simulate a radio DJ, advertising the play list through messages and transmissions on the social networking portion of the site. During the ‘streaming’ of music from the aforementioned playlists, the user may have an account with the service provider for the system and using coupon or paid money-credits, can pay the service provider royalties if required for the streaming of music and the service pays record companies to stream their music and in turn the record companies pay the artists.

In another favored mode of the system, advertisers are provided with means for audio advertising between, before, or after songs for example. Many advertisers sponsor concerts and tours of various artists and the system herein provides the ability for such advertisers to gain individual users of the system as customers. The artists would be provided revenue from one or both of the record companies and the advertisers, and as such, in this action of the business method, the artists, record companies, and advertisers are provided with a user-encouraged source of revenue 18.

Artists and music genre information including news updates, concert schedules, etc. are provided via specific web pages and links thereto on the system which are tailored to that artist or genre. By visiting these pages, or similarly opting to receive regular occurrences of information, users or fans are provided with encouragement to use the site and pay for music therefrom by the ability to stay up to date with news, biographies, videos, music, and merchandise about the artists in order to maintain a connection as such.

Further, employing the social networking side of the system, users can communicate electronic messages to like minded friends that they are attending an upcoming concert and similarly see if their friends are attending in order to stay socially connected to them. Furthermore, when visiting these pages or indicating attendance to a certain concert or show, the user may be prompted with notices showing similar or comparable artists that the user may also enjoy. This allows many unfamiliar artists to be noticed when up against popular artists of similar taste, thereby encouraging expansion of musical artists.

As a particularly preferred action of the system herein of the present invention, when users legally purchase an album or digital songs of a musical group, and/or purchase a concert ticket for a group through the service provider, the user will be provided coupons or deal codes or coupon codes or the like which are good for one or a plurality of incentives to legally purchase artists' merchandise 20. Merchandise can primarily include a group of merchandise items including albums, individual songs, apparel, accessories, and more. Thus, legal music purchases are rewarded as are legal attendance at concerts.

In another mode, it is preferred that the incentive to buy merchandise 20, is also an incentive to legally buy digital music by providing a discount using a provided code or coupon identifier for discounted or free concert tickets to the user's favorite artists, or alternatively may be discount codes or coupons for discounts on other merchandise and so forth, depending on the total sale amount. These incentives for merchandise or concerts for legal music purchases, will draw in further revenue for artists 22 as conventional merchandise sales have continued to drop due to the provision of current online digital music sales. The same incentives for legal purchase of digital music, can also be given for purchases of concert tickets. In this case the discount codes provided would of course be for merchandise, and for a discount on a digital music purchase. This of course also encourages the legal purchase of digital music by rewarding legal attendance at concerts.

When the user receives the digital music, or a concert ticket in the mail or email, or in the case of a digital sale, completes a download, concurrently communicated to the user will be a means to receive or use the incentive noted above. This can include an activation code, coupon code, discount code, or a physical coupon or the like. This code can then be entered through the server of the service provider using software adapted to the task of input of discount identifiers and applying them to the appropriate product, to provide the user with the free or discounted concert/festival/show ticket.

It is of yet another preference that the concert/festival/show for which discounts are given for legal music purchases is provided via artist touring dates contracted through the service provided by disclosed business method. Artists that sign a contract, agree to tour a specified period of time in the United States and the UK. The tours include artists' lineups that link together similar artists further aiding to bring fans to the music and genre they enjoy and love. As such, artists that would tour anyway, can now tour with other artists and reach a larger audience. Fans who are the users herein are thus given the opportunity to see multiple artist as well as discover new ones.

Further, such tours including concerts, festivals, or one time shows that users attend 24 provide advertisers with additional means to advertise, creating revenue 28. For example, PEPSI may be the only soda at festivals, as they pay a significant amount to advertise through the service as pop up or other ads. Further, artists can sell merchandise to further increase revenue 26.

Finally, as noted above, the system may easily be enabled to provide users a feature which will help connect users who play music, such as new bands, in finding fellow, like minded musicians. Using software adapted to the task of maintaining a database of users who play music, and their type of instrument and locale and schedule, groups needing instrument players may be put in communication with users who play and users who play instruments not wanting a group can be put in communication with like minded users.

Additionally, musician users could upload samples of their instrument play, which would be associated with their profile and accessible to users searching for their type of instrument, musical likes, and geographic location. Thus the system will allow musician users to get in contact with other musicians, listen to their music as a means to determine if the user musician is a fit for the band, and to arrange for a group session and perhaps form a musical band. Thus the system may be employed as a means of facilitating the formation of musical groups and music produced by such groups and for augmenting the musicians in formed groups.

The disclosed business method and service provided therein provides more income to artists, record companies, and advertisers. Further, fans are provided with a substantially beneficial experience simply by supporting their favorite artists and staying connected.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A system for rewarding a legal purchase of music or live performance tickets comprising the steps of:
communicating over a network with user computing devices from a server of a system provider;
using software adapted to intake provided user information running on said server to form a user profile;
allowing said user to include music preference in said user profile;
using a relational database and software adapted to ascertain matches between respective said music preference, communicating to users individual and groups of other said users having a similar said music preference;
providing electronic communication between said like minded users;
allowing users to purchase digital music of a musical group of musician or live performance tickets of said musical group or said musician, over said network through said system provider;
ascertain that any required monetary payment to said musical group or said musician for said digital music or said live performance;
communicating discount identifiers associated with merchandise related to said musical group or said musician, to users purchasing said digital music or live performance tickets; and
allowing said users having possession of said discount identifiers, to employ them to obtain discounts on purchases of said merchandise related to said musical group; and
ascertaining said musician or musical group is communicated any monetary payment due for said merchandise.

2. The system of claim 1 additionally comprising the steps of:
allowing said users to assemble and store in computer memory of a computing device connected with said server, one or more digital playlists which include one or a plurality of individual performances of digital music purchased by said user;
allowing said users having said playlists, to communicate said playlists electronically, to other said users designated by said users having said playlists; and
ascertaining said musician or said musical group is paid for any monetary payment due for assembly or communication of said playlists.

3. The system of claim 1 additionally comprising the steps of:
communicating access to said users to software adapted to the task of searching said relational database, whereby said users can search said relational database for other said users having similarities in their respective said profiles; and
providing electronic communication between said users who opt to allow such communication, and other said users who are ascertained in a search of said database to have said similarities.

4. The system of claim 1 additionally comprising the steps of:
communicating to users who purchase said digital music of a musician or musical group, said discount identifiers which provide, a discount to purchase or a free said live performance ticket for said musician or musical group, thereby providing monetary encouragement to purchase said digital music in a fashion where said musical group or musician is recompensed.

5. The system of claim 1 additionally comprising the steps of:
communicating to users who purchase said live performance tickets for a musician or musical group, said discount identifiers which provide, a discount to purchase said digital music of said musician or musical group, thereby providing monetary encouragement to purchase said live performance tickets in a fashion where said musical group or musician is recompensed.

6. The system of claim 1 additionally comprising the steps of:
providing communication between said users and advertisers based on user information in respective said user profiles; and
allowing said advertisers to communicate said discount identifiers to said users which are based on products of or sponsored by said advertiser.
